(19) United States
(12) Patent Application Publication
(10) Pub. No.: US 2015/0066625 A1
(43) Pub. Date: Mar. 5, 2015

(54) INCENTIVES FOR ACKNOWLEDGING PRODUCT ADVERTISING WITHIN MEDIA CONTENT

(71) Applicant: Microsoft Corporation, Redmond, WA (US)

(72) Inventors: Cierra McDonald, Bothell, WA (US); Mike Horstmanshof, Shoreline, WA (US); Sela Davis, Seattle, WA (US); Craig Suthers, Seattle, WA (US); Cody Luitjens, Seattle, WA (US); Nick Koller, Seattle, WA (US); Doug Beck, Bothell, WA (US); Don Sprague, Seattle, WA (US); Michael Alyn Miller, Redlands, CA (US); Keith Kline, Bothell, WA (US)

(73) Assignee: Microsoft Corporation, Redmond, WA (US)

(21) Appl. No.: 14/019,485

(22) Filed: Sep. 5, 2013

(51) Int. Cl. G06Q 30/02

(52) U.S. Cl. CPC G06Q 30/0239
USPC 705/14.39

(57) ABSTRACT

A cloud-based service provides incentives for users of devices such as game consoles, personal computers, smartphones, and the like to explicitly acknowledge product placements within media content by offering rewards to the users that may be obtained by performing certain user actions as the media content is being consumed and rendered on the device. The user actions may comprise clicking a button or performing a gesture to an input device, for example, at particular times in the media content presentation in which a branded product is shown, mentioned, or used. A client component on the device captures the user actions as signals which are sent to the service which compares the signals against known reward criteria. If reward criteria are met by the user actions, the service can provide either digital or physical rewards to the user.

### BACKGROUND

Companies have long used traditional advertising approaches, such as commercials that run during television shows and prior to movie screenings, to reach television and movie viewers and attempt to convert them into customers. More recently, companies have expanded their approach using a product integration or product placement model in which their products or brands are incorporated within the television or movie content itself. For example, a character in a show might interact with the placed product as a prop, or refer to it in some manner. While such models can work satisfactorily in some cases, there is currently no tangible incentive for viewers to pay attention to the placed products, nor are there reliable mechanisms for companies to determine whether viewers notice or are responding to the advertising for which they expend resources to create and display.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A cloud-based service provides incentives for users of client devices such as game consoles, personal computers, smartphones, and the like to explicitly acknowledge product placements within media content by offering rewards to the users that may be obtained by performing certain user actions as the media content is being consumed and rendered on the device. The user actions may comprise clicking a button or performing a gesture to an input device, for example, at particular times in the media content presentation in which a branded product is shown, mentioned, or used. A client component on the device captures the user actions as signals which are sent to the service which compares the signals against known reward criteria. If reward criteria are met by the user actions, the service can provide either digital or physical rewards to the user.

In various illustrative examples, the reward criteria are expressed through rules that may be formulated by a brand owner who has advertising in the form of product placements in media content such as television shows and movies. The rules are used to derive metadata that is sent to the client device along with the media content and used to create an advertising acknowledgement user experience. Reward offers and the corresponding user actions to be performed to obtain the rewards can be populated into a user interface hosted on the client device and shown to the user as instructions. As user actions are performed during the course of the media content consumption, the user interface may be configured, for example, to indicate the progress made towards a reward and indicate when a reward has been achieved. The service can track explicit product advertising acknowledgements among a population of users and generate reports that include measureable indicators of a given product placement's reach with the population.

Advantageously, the present incentives for acknowledging product advertising empowers brand owners to reward consumers for explicitly acknowledging their advertisements within media content and receive quantitative data from the service as to their product placement effectiveness. In addition, the service enables brand owners to define new advertising acknowledgement criteria at any time without adjusting the media content or the in-content advertisements themselves.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative cloud-computing environment in which the present incentives for acknowledging product advertising within media content may be implemented;

FIG. 2 shows illustrative rules provided by a brand owner that may govern particular incentives for acknowledging product advertising within media content;

FIG. 3 shows how rules may be utilized to express various advertising acknowledgement criteria;

FIG. 4 shows an illustrative arrangement in which media content including metadata is provided by an entertainment service to a client device;

FIG. 5 shows an illustrative advertising acknowledgement client that resides on a computing device such as multimedia console;

FIG. 6 is a flowchart of an illustrative method that implements incentives for acknowledging product advertisement within media content;

FIG. 7 shows an illustrative arrangement in which captured signals are sent to an incentive and reward service;

FIG. 8 shows an illustrative arrangement in which the incentive and reward service generates and delivers reports;

FIG. 9 is an illustrative functional block diagram of a multimedia console;

FIG. 10 is a simplified block diagram of an illustrative computer system such as a personal computer (“PC”) that may be used in part to implement the present incentives for acknowledging product advertising within media content; and

FIG. 11 shows a block diagram of an illustrative computing platform that may be used in part to implement the incentives for acknowledging product advertising within media content.

Like reference numerals indicate like elements in the drawings. Elements are not drawn to scale unless otherwise indicated.

### DETAILED DESCRIPTION

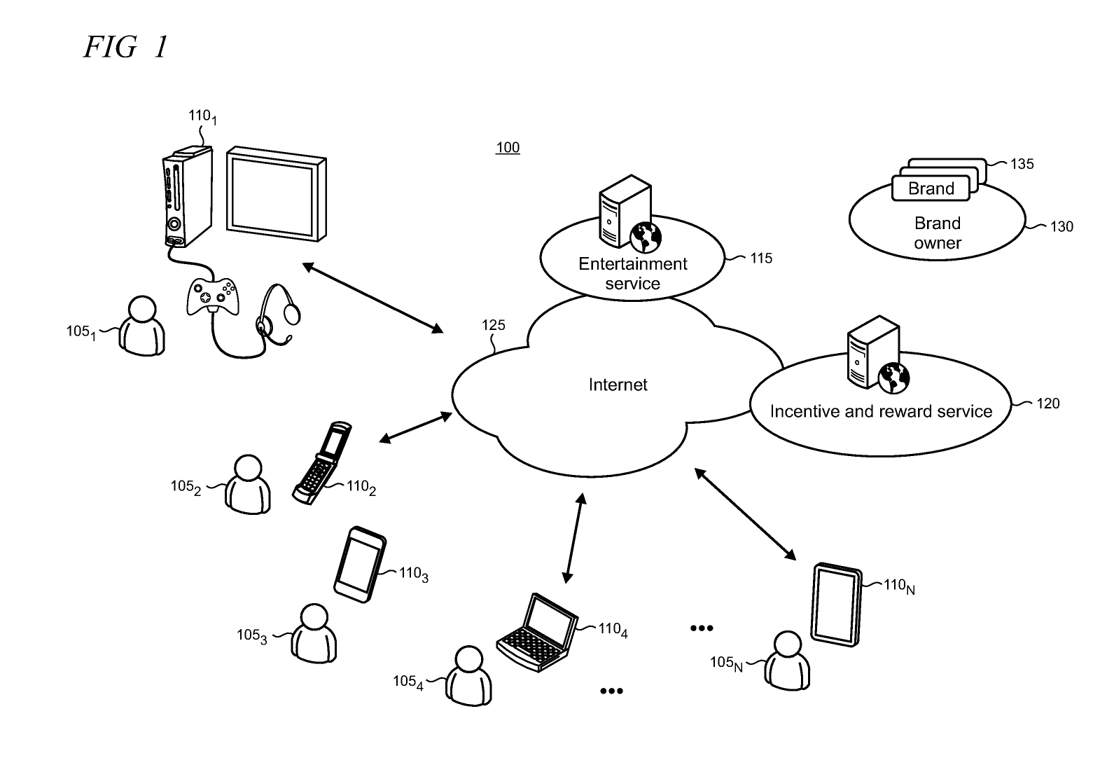

FIG. 1 shows an illustrative cloud-computing environment 100 in which the present incentives for acknowledging product advertising within media content may be implemented. Users 105 of a variety of client devices 110 including multimedia consoles, mobile phones, smartphones, tablets, personal computers (“PCs”), personal digital assistants (“PDAs”), handheld gaming platforms, personal media players, wearable computers, navigation devices, and the like, which can consume and/or render media content may interact with an entertainment service 115 as well as an incentive and reward service 120 over a network such as the Internet 125. In some implementations, the entertainment service 115 and the incentive and reward service 120 may be combined into a common service or be operated by a common provider. The incentive and reward service 120 may also be incorporated into an achievement system or service in some cases.

As shown in FIG. 1, a brand owner 130 is also present in the environment 100. The brand owner 130 may own or control one or more brands 135 that are associated with respective products and services. Typically, during pre-production, production, or post-production of media content such as a television show or a movie, for example, the brand owner negotiates an arrangement with the media content producers. The arrangement, commonly termed “product placement” or “product integration,” allows for the brand owner's product or brand to be displayed, mentioned, or used within the television show or movie. That is, the user can see the product or hear about it while they consume the media content. The show or movie may then be distributed and made available to viewers for consumption on broadcast and cable television, at theaters, or online through various services such as the entertainment service 115. Such integrated or placed branded products and services are referred to as “advertising” in the description that follows and it is noted that use of the term “product advertising” is intended to be applicable to either products or services.

It is emphasized that with the present incentives for acknowledging product advertising, there is no need that the product placement be implemented for a given show or movie at any particular time. Media content often has a long life expectancy and it is not unusual that media content be in demand for many years and even decades. Accordingly, it is possible that either or both older and newer media content includes existing product placements that are of interest to the brand owner 130. It is further emphasized that no changes need to be made to the media content itself, or the embedded advertising in order to implement the present incentives for acknowledging product advertising. That is, while an additional dimension of interactivity is provided to the user in order to participate in advertising acknowledgement and gain a reward, the users 105 can otherwise interact and consume the media content as they always have and the content looks and behaves conventionally.

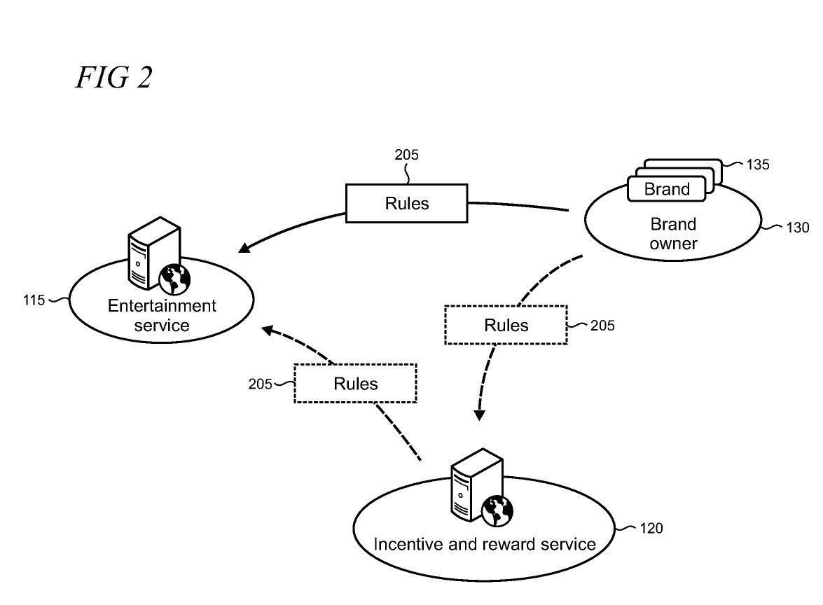

FIG. 2 shows illustrative rules 205, provided by the brand owner 130, that may govern particular incentives for a given piece of media content. The rules 205 are typically provided by the brand owner 130 to the entertainment service 115. However, in some cases, the rules 205 may be furnished to the incentive and reward service 120 which can forward the rules 205 to the entertainment service 115. The incentive and reward service 120 may edit or supplement the rules in some implementations, and the service 120 may also generate rules on behalf of brand owner 130 or in collaboration with the brand owner. Likewise, the entertainment service 115 may also contribute to rule generation, and collaboration between all the entities shown in FIG. 2 may also be implemented in some scenarios.

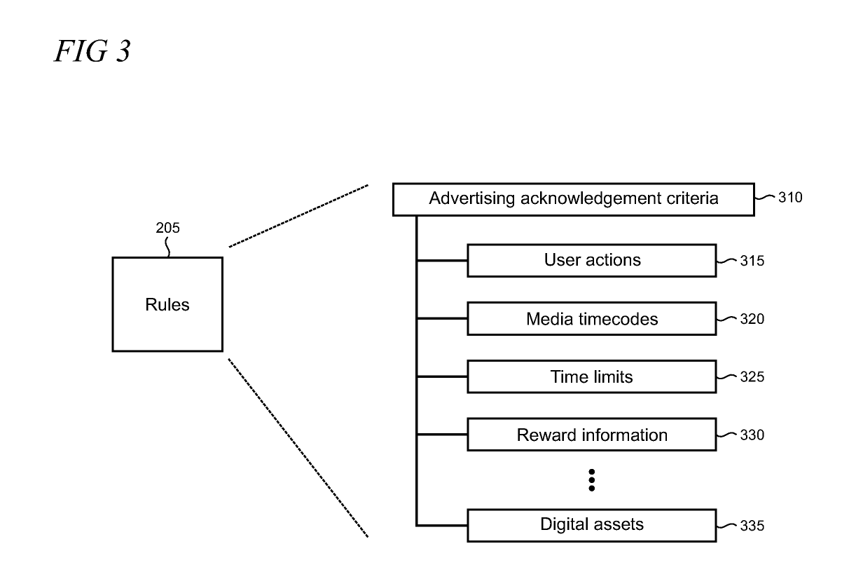

As shown in FIG. 3, the rules 205 may be utilized to express advertising acknowledgement criteria 310 (i.e., reward criteria). The advertising acknowledgement criteria 310 are typically instantiated on a media content title-by-title basis so that the criteria will be different for different television shows and movies. However, in some scenarios, the same advertising acknowledgement criteria can be utilized across multiple media content titles. The brand owner 130 may tailor the advertising acknowledgement criteria 310 to meet particular objectives so it is possible that not all of the criteria shown in FIG. 3 will be used in every situation and it is further possible that the brand owner may choose to utilize advertising acknowledgement criteria that are not shown or described herein.

The advertising acknowledgement criteria 310, in this illustrative example, include user actions 315, media timecodes 320, and time limits 325. The advertising acknowledgement criteria 310 can also include reward information 330, and various digital assets 335. The user actions 315 comprise a description of the various actions a user 105 (FIG. 1) can take during the course of media content consumption in order to obtain one or more rewards (as described in the reward information 330). The brand owner 130 (FIG. 1) can choose user actions to be used for a given media content title from among a broad scope of possible actions. For example, the user 105 may be asked to perform some type of input action to a client device 110 every time the user sees a particular product X. The input action could include a button push, voice input, or input gesture depending on the particular type of input devices supported on a given client device 110. In the case of a multimedia console that is equipped with motion-capture capability as well as traditional controllers, the requested input action could include a press of a button on the controller, or a wave of a hand that is captured by a motion-capture device.

The media timecodes 320 may be utilized by the brand owner 130 to provide additional specificity to the advertising acknowledgement criteria 310. For example, the media timecodes 320 may specify a particular time, or time interval in the media content title in which a user action is requested. Here, to be eligible for the reward, the user 105 could be asked to perform a button push on the client device 110 within a 10 second window when the user sees product X seven minutes and three seconds after a particular television show begins.

The time limits 325 may be utilized by the brand owner 130 to provide additional specificity to the advertising acknowledgement criteria 310 so that the user 105 can participate in advertising acknowledgement and be eligible to receive a reward only at certain specified times. For example, the time limits 325 could specify a date after which participation is restricted, times of the day and/or days of the week that participation is enabled, the number of rewards that can be obtained within a particular time interval, and the like. The brand owner 130 may also specify other eligibility criteria that are not time-related such as the imposition of restrictions on the total number of rewards received by a given user, or awarded for a given media content title, for example.

The reward information 330 may be utilized by the brand owner 130 to provide details about the particular reward being offered including what is being offered. In some cases, the brand owner may specify the advertising acknowledgement criteria 310 so that a reward can be earned after the user performs a single user action. In other cases, the reward may be earned only after multiple user actions are performed. The brand owner 130 may also specify the criteria 310 in a way that a user is asked to perform user actions across multiple media consumption sessions and/or across multiple titles in order to be eligible to receive a reward.

The brand owner 130 may specify digital assets 335 such as particular media objects including graphics, text, sounds, video, animations, and the like that may be associated with a particular brand and which may be utilized at the client device when building a user experience as part of advertising acknowledgement. For example, such media objects can be variously rendered to the user 105 at the client device 110 when the user is informed about the reward opportunities when consuming a media content title, during user actions, and when rewards are successfully achieved.

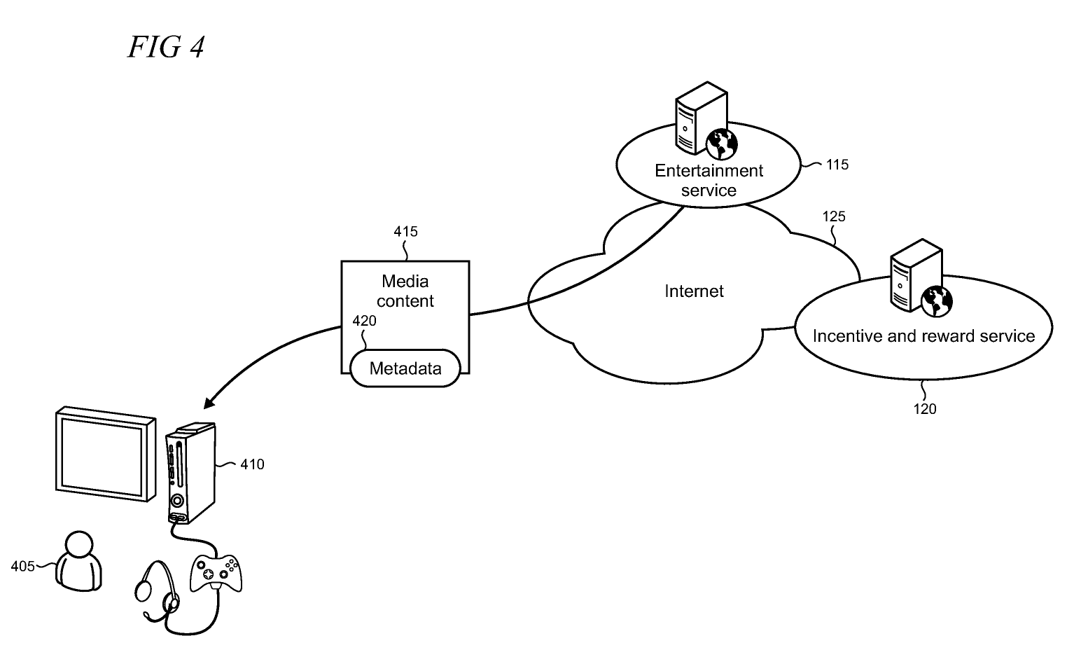

In an illustrative example, as shown in FIG. 4, a user 405 of a multimedia console 410 receives a piece of media content 415 from the entertainment service 115, for example as a download or as content that is streamed to the console over the Internet 125. The media content 415 is associated with metadata 420 that is included as a portion of the download or stream to the multimedia console 410. The metadata 420 is utilized at the multimedia console 410 to create the advertising acknowledgement user experience for the media content 415.

Typically, the metadata includes information that is derived from the advertising acknowledgement criteria 310 (FIG. 3) specified by the brand owner. For example, the metadata 420 may be utilized and/or include code to generate the user interface, populate the user interface with information (including text, graphics, and animations in some cases) about the rewards being offered, the user actions to be taken to receive a reward, the timeframes during which users may participate and be eligible to receive rewards. The user interface can also be configured to display media and/or control objects such as user selectable virtual buttons at an appropriate timecode during media content presentation so that the user can press the button to acknowledge that product advertising has been viewed. The user interface may also be used to show how close a user may be to achieving an reward, when a reward has been achieved, as well as provide other ways for the user to interact with the incentive and reward service 120.

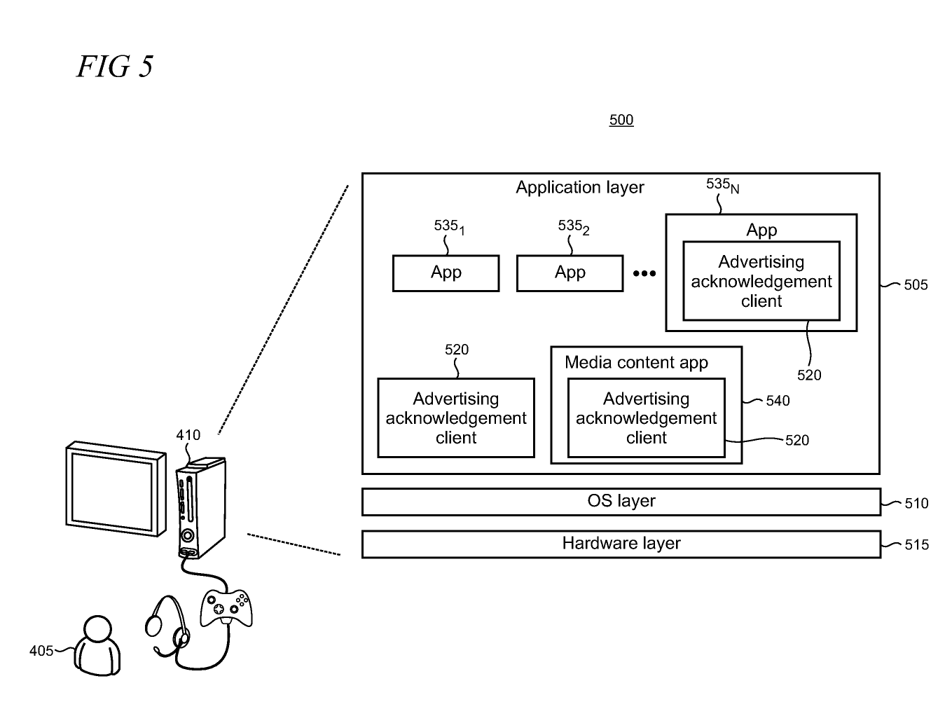

FIG. 5 shows an illustrative architecture 500 of functional components that may be instantiated on a client device such as the multimedia console 410. The architecture 500 is typically implemented in software, although combinations of software, firmware, and/or hardware may also be utilized in some cases. The architecture 500 is arranged in layers and includes an application layer 505, an OS (operating system) layer 510, and a hardware layer 515. The hardware layer 515 provides an abstraction of the various hardware used by the multimedia console 410 (e.g., input and output devices, networking hardware, etc.) to the layers above it.

As shown in FIG. 5, the application layer 505 supports a variety of native applications 535_{1, 2 . . . N} that are generally implemented using locally executing code for the most part. In some cases, however, the native applications 535 may also rely on services and/or remote code execution provided by remote servers. The application layer 505, in this example, supports an advertising acknowledgement client 520 that captures the user signals that are generated during the user's interaction with the media content when acknowledging advertising and sends them to the incentive and reward service 120. The signals are typically implemented to be representative of user's actions, inputs, behaviors, and the like so that the interaction can be subsequently compared against the advertising acknowledgement criteria 310 (FIG. 3) specified by the brand owner to determine reward eligibility. The advertising acknowledgement client 520 may also be configured in some implementations to use the metadata 420 (FIG. 4) to create the advertising acknowledgement user experience either substantially on its own, or in combination with other components that are running on the multimedia console 410.

The advertising acknowledgement client 520 may be instantiated as a standalone component and/or be incorporated within an application 535 or a media content application 540 which is associated with the entertainment service 115 (FIG. 1) which also typically resides in the application layer 505. Alternatively, the advertising acknowledgement client may be distributed across multiple components in the application layer 505. While the advertising acknowledgement client 520 resides in the application layer 505 in this illustrative example, in alternative arrangements the advertising acknowledgement client 520 may be incorporated in various components in the OS layer 510 or hardware layer 515, or its functionality distributed across two or more layers in the architecture 500.

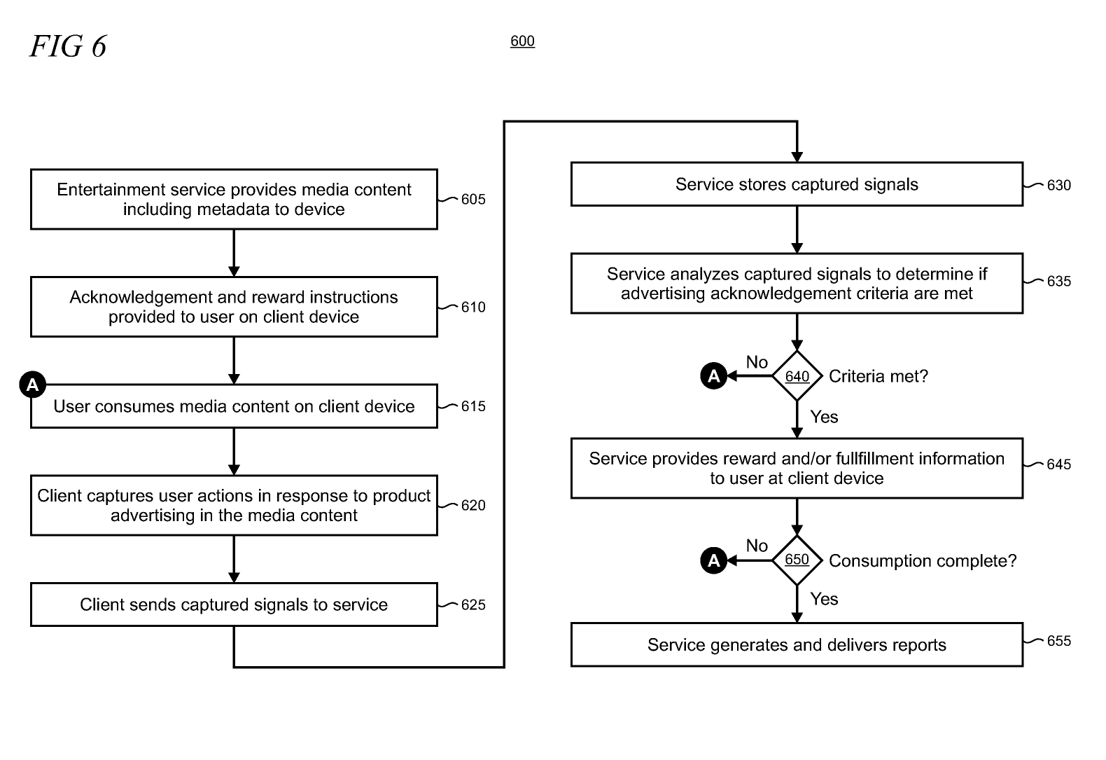

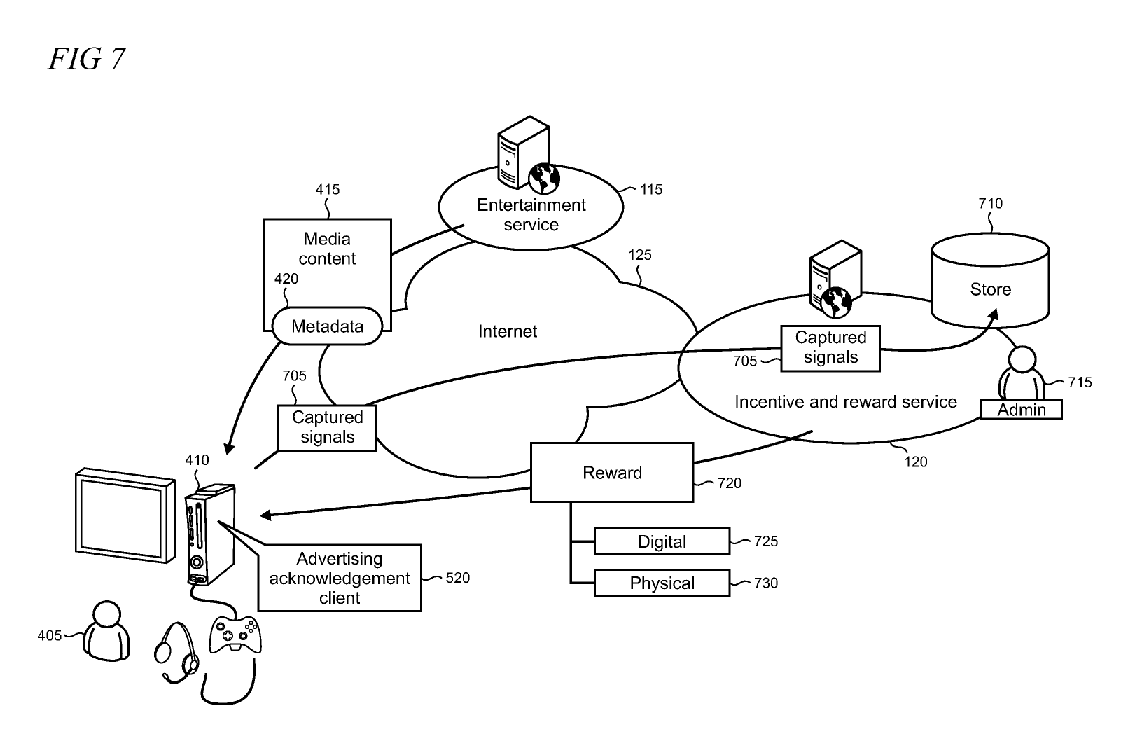

FIG. 6 is a flowchart of an illustrative method 600 for implementing incentives for acknowledging product advertising within media content. The reader may wish to refer to FIG. 7 as the discussion of flowchart 600 is presented below. Unless specifically stated, the methods or steps shown in the flowchart and described below are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

At block 605 in FIG. 6, the entertainment service 115 provides a piece of media content 415 along with metadata 420 to the client multimedia console 410. Typically, when the media content 415 loads and/or begins playing, advertising and acknowledgement instructions are populated into a user interface that is hosted on the client multimedia console, as indicated at block 610. The instructions may be generated using information in the received metadata 420 and be used to inform the user 405 about the rewards being offered and the user actions that can be taken to obtain them. The instructions are typically recallable upon user request as the media content is consumed or may be periodically displayed as the media content is rendered to remind the user of reward opportunities.

At block 615, the user 405 consumes the media content 415 and performs user actions as product advertising occurs during the course of the consumption. At block 620, the advertising acknowledgement client 520 captures signals that are representative of the user actions, in response to product advertising, that are performed as the media content 415 is rendered. At block 625, the advertising acknowledgement client 520 sends the captured signals 705 to the incentive and reward service 120 which will typically archive the captured signals in a store 710, at block 630.

At block 635, the incentive and reward service 120 analyzes the captured signals 705 and in view of the rules 205 and advertising acknowledgement criteria 310, to determine if criteria to obtain a reward have been met by the user's actions. In typical implementations, the incentive and reward service will perform a review and analysis of captured signals in an automated manner without the need for intervention by a human operator. However, in some cases an administrator 715 may perform some amount of manual review, for example, if an unusual fact pattern emerges, or to ensure system performance and quality.

At decision block 640, if the criteria have been met for a reward, then at block 645 the incentive and reward service 120 can send a reward 720 to the user 405 which can either be embodied as a digital reward 725, a physical reward 730, or a combination of digital and physical. In the case of a digital reward 725, the incentive and reward service 120 can typically fulfill the reward directly. For example, the digital reward can include points in a travel club, frequent flyer miles, electronic coupons for goods, vacations and services, media content (e.g., a free television show or movie stream or download), virtual badges, artwork, screen savers, sneak peek content, early access to content, subscription extensions, and the like, as the brand owner deems appropriate. It is emphasized that the foregoing list is intended to be illustrative and that the digital rewards may comprise any of a variety of rewards having any value and are not limited to only these illustrative examples.

In the case of physical rewards 730, the incentive and reward service 120 may provide fulfillment instructions to the user so that the physical reward can be redeemed. For example, the instructions can direct the user to a third party website and include a promotion code or similar device that enables the user to place an order for the physical reward. Alternatively, the instructions may direct the user to a convenient physical facility for reward fulfillment. As with the digital rewards 725, the physical rewards 730 are not limited and can take any form, from stickers to automobiles, as the brand owner deems appropriate.

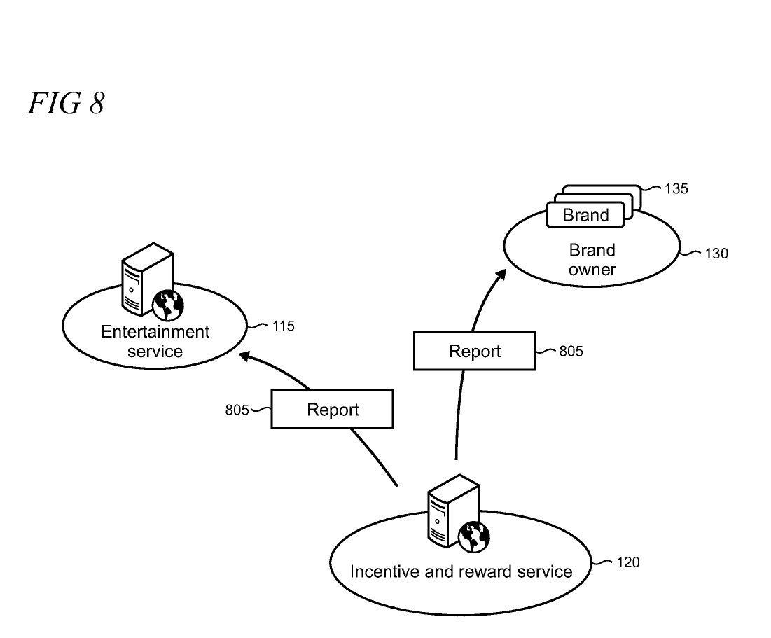

If at decision block 640 the reward criteria have not been met, then control returns back to block 615 as shown. At decision block 650, if the user has not completed consumption of the media control returns back to block 615. If consumption is complete then at block 655, the incentive and reward service 120 can generate and deliver various types of reports. For example, the reports may include statistical or other data that represents the number of users who sent signals indicating that they have explicitly acknowledged advertising within media content over some time interval and the trending of such acknowledgements by media content title. Similarly, the incentive and reward service 120 may include data in the reports that represents the number of users who did not explicitly acknowledge the advertising, and the trending by media content title. As shown in FIG. 8, the incentive and reward service 120 may transmit reports 805 to one or both of the entertainment service 115 and content brand owner 130.

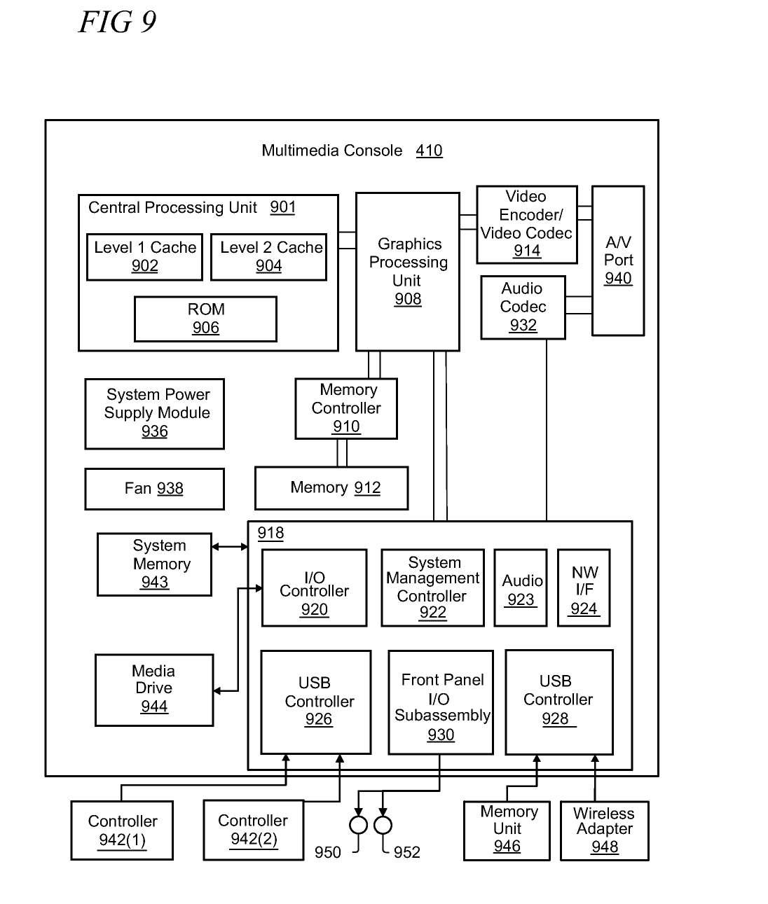

FIG. 9 is an illustrative functional block diagram of the multimedia console 410 shown in FIGS. 4, 5, and 7. As shown in FIG. 9, the multimedia console 410 has a central processing unit (CPU) 901 having a level 1 cache 902, a level 2 cache 904, and a Flash ROM (Read Only Memory) 906. The level 1 cache 902 and the level 2 cache 904 temporarily store data and hence reduce the number of memory access cycles, thereby improving processing speed and throughput. The CPU 901 may be configured with more than one core, and thus, additional level 1 and level 2 caches 902 and 904. The Flash ROM 906 may store executable code that is loaded during an initial phase of a boot process when the multimedia console 410 is powered ON.

A graphics processing unit (GPU) 908 and a video encoder/video codec (coder/decoder) 914 form a video processing pipeline for high speed and high resolution graphics processing. Data is carried from the GPU 908 to the video encoder/video codec 914 via a bus. The video processing pipeline outputs data to an A/V (audio/video) port 940 for transmission to a television or other display. A memory controller 910 is connected to the GPU 908 to facilitate processor access to various types of memory 912, such as, but not limited to, a RAM.

The multimedia console 410 includes an I/O controller 920, a system management controller 922, an audio processing unit 923, a network interface controller 924, a first USB host controller 926, a second USB controller 928, and a front panel I/O subassembly 930 that are preferably implemented on a module 918. The USB controllers 926 and 928 serve as hosts for peripheral controllers 942(1)-942(2), a wireless adapter 948, and an external memory device 946 (e.g., Flash memory, external CD/DVD ROM drive, removable media, etc.). The network interface controller 924 and/or wireless adapter 948 provide access to a network (e.g., the Internet, home network, etc.) and may be any of a wide variety of various wired or wireless adapter components including an Ethernet card, a modem, a Bluetooth module, a cable modem, or the like.

System memory 943 is provided to store application data that is loaded during the boot process. A media drive 944 is provided and may comprise a DVD/CD drive, hard drive, or other removable media drive, etc. The media drive 944 may be internal or external to the multimedia console 410. Application data may be accessed via the media drive 944 for execution, playback, etc. by the multimedia console 410. The media drive 944 is connected to the I/O controller 920 via a bus, such as a Serial ATA bus or other high speed connection (e.g., IEEE 1394).

The system management controller 922 provides a variety of service functions related to assuring availability of the multimedia console 410. The audio processing unit 923 and an audio codec 932 form a corresponding audio processing pipeline with high fidelity and stereo processing. Audio data is carried between the audio processing unit 923 and the audio codec 932 via a communication link. The audio processing pipeline outputs data to the A/V port 940 for reproduction by an external audio player or device having audio capabilities.

The front panel I/O subassembly 930 supports the functionality of the power button 950 and the eject button 952, as well as any LEDs (light emitting diodes) or other indicators exposed on the outer surface of the multimedia console 410. A system power supply module 936 provides power to the components of the multimedia console 410. A fan 938 cools the circuitry within the multimedia console 410.

The CPU 901, GPU 908, memory controller 910, and various other components within the multimedia console 410 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 410 is powered ON, application data may be loaded from the system memory 943 into memory 912 and/or caches 902 and 904 and executed on the CPU 901. The application may present a graphical user interface that provides a consistent user experience when navigating to different media types available on the multimedia console 410. In operation, applications and/or other media contained within the media drive 944 may be launched or played from the media drive 944 to provide additional functionalities to the multimedia console 410.

The multimedia console 410 may be operated as a standalone system by simply connecting the system to a television or other display. In this standalone mode, the multimedia console 410 allows one or more users to interact with the system, watch movies, or listen to music. However, with the integration of broadband connectivity made available through the network interface controller 99 or the wireless adapter 948, the multimedia console 410 may further be operated as a participant in a larger network community.

When the multimedia console 410 is powered ON a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation is typically large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size, and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 410 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 901 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 942(1) and 942(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The capture device 113 may define additional input devices for the console 410.

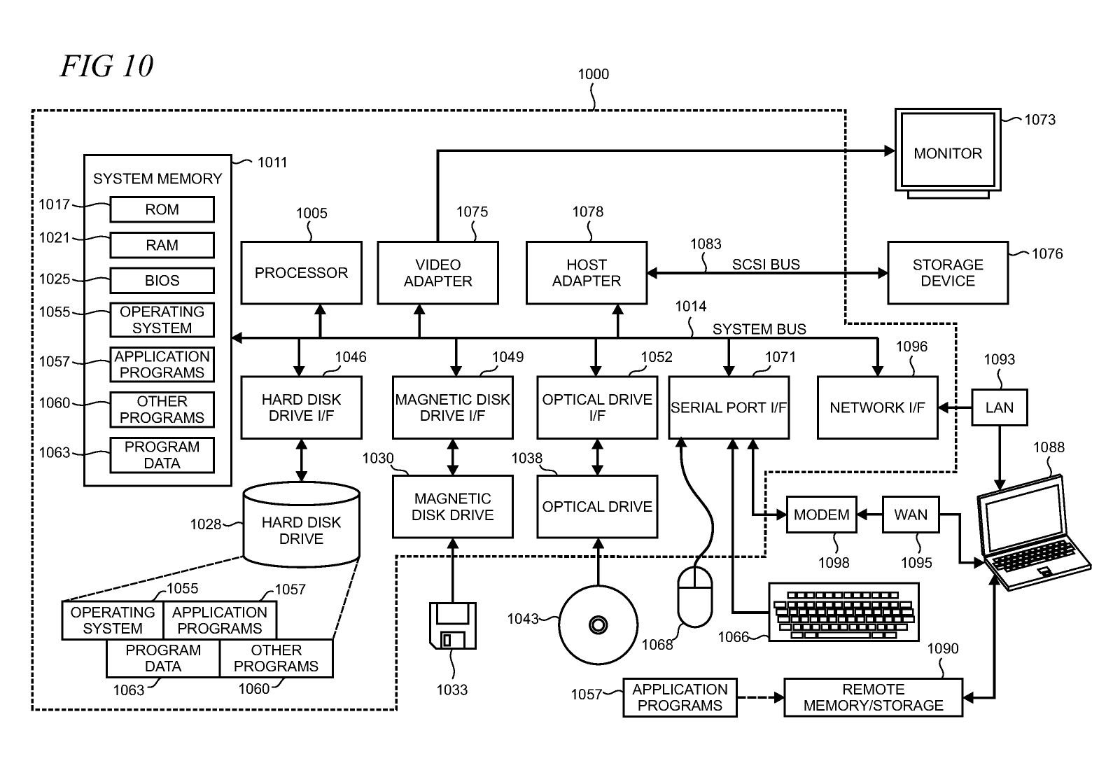

FIG. 10 is a simplified block diagram of an illustrative computer system 1000 such as a PC, client device, or server with which the present incentives for acknowledging product advertising within media content may be implemented. Computer system 1000 includes a processing unit 1005, a system memory 1011, and a system bus 1014 that couples various system components including the system memory 1011 to the processing unit 1005. The system bus 1014 may be any of several types of bus structures including a memory bus or memory controller, a peripheral bus, and a local bus using any of a variety of bus architectures. The system memory 1011 includes read only memory (“ROM”) 1017 and random access memory (“RAM”) 1021. A basic input/output system (“BIOS”) 1025, containing the basic routines that help to transfer information between elements within the computer system 1000, such as during startup, is stored in ROM 1017. The computer system 1000 may further include a hard disk drive 1028 for reading from and writing to an internally disposed hard disk (not shown), a magnetic disk drive 1030 for reading from or writing to a removable magnetic disk 1033 (e.g., a floppy disk), and an optical disk drive 1038 for reading from or writing to a removable optical disk 1043 such as a CD (compact disc), DVD (digital versatile disc), or other optical media. The hard disk drive 1028, magnetic disk drive 1030, and optical disk drive 1038 are connected to the system bus 1014 by a hard disk drive interface 1046, a magnetic disk drive interface 1049, and an optical drive interface 1052, respectively. The drives and their associated computer readable storage media provide non-volatile storage of computer readable instructions, data structures, program modules, and other data for the computer system 1000. Although this illustrative example shows a hard disk, a removable magnetic disk 1033, and a removable optical disk 1043, other types of computer readable storage media which can store data that is accessible by a computer such as magnetic cassettes, flash memory cards, digital video disks, data cartridges, random access memories (“RAMs”), read only memories (“ROMs”), and the like may also be used in some applications of the present incentives for acknowledging product advertising within media content. In addition, as used herein, the term computer readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 1033, optical disk 1043, ROM 1017, or RAM 1021, including an operating system 1055, one or more application programs 1057, other program modules 1060, and program data 1063. A user may enter commands and information into the computer system 1000 through input devices such as a keyboard 1066 and pointing device 1068 such as a mouse. Other input devices (not shown) may include a microphone, joystick, game pad, satellite dish, scanner, trackball, touchpad, touch screen, touch-sensitive module or device, gesture-recognition module or device, voice recognition module or device, voice command module or device, or the like. These and other input devices are often connected to the processing unit 1005 through a serial port interface 1071 that is coupled to the system bus 1014, but may be connected by other interfaces, such as a parallel port, game port, or universal serial bus (“USB”). A monitor 1073 or other type of display device is also connected to the system bus 1014 via an interface, such as a video adapter 1075. In addition to the monitor 1073, personal computers typically include other peripheral output devices (not shown), such as speakers and printers. The illustrative example shown in FIG. 10 also includes a host adapter 1078, a Small Computer System Interface (“SCSI”) bus 1083, and an external storage device 1076 connected to the SCSI bus 1083.

The computer system 1000 is operable in a networked environment using logical connections to one or more remote computers, such as a remote computer 1088. The remote computer 1088 may be selected as another personal computer, a server, a router, a network PC, a peer device, or other common network node, and typically includes many or all of the elements described above relative to the computer system 1000, although only a single representative remote memory/storage device 1090 is shown in FIG. 10. The logical connections depicted in FIG. 10 include a local area network (“LAN”) 1093 and a wide area network (“WAN”) 1095. Such networking environments are often deployed, for example, in offices, enterprise-wide computer networks, intranets, and the Internet.

When used in a LAN networking environment, the computer system 1000 is connected to the local area network 1093 through a network interface or adapter 1096. When used in a WAN networking environment, the computer system 1000 typically includes a broadband modem 1098, network gateway, or other means for establishing communications over the wide area network 1095, such as the Internet. The broadband modem 1098, which may be internal or external, is connected to the system bus 1014 via a serial port interface 1071. In a networked environment, program modules related to the computer system 1000, or portions thereof, may be stored in the remote memory storage device 1090. It is noted that the network connections shown in FIG. 10 are illustrative and other means of establishing a communications link between the computers may be used depending on the specific requirements of an application of incentives for acknowledging product advertising within media content.

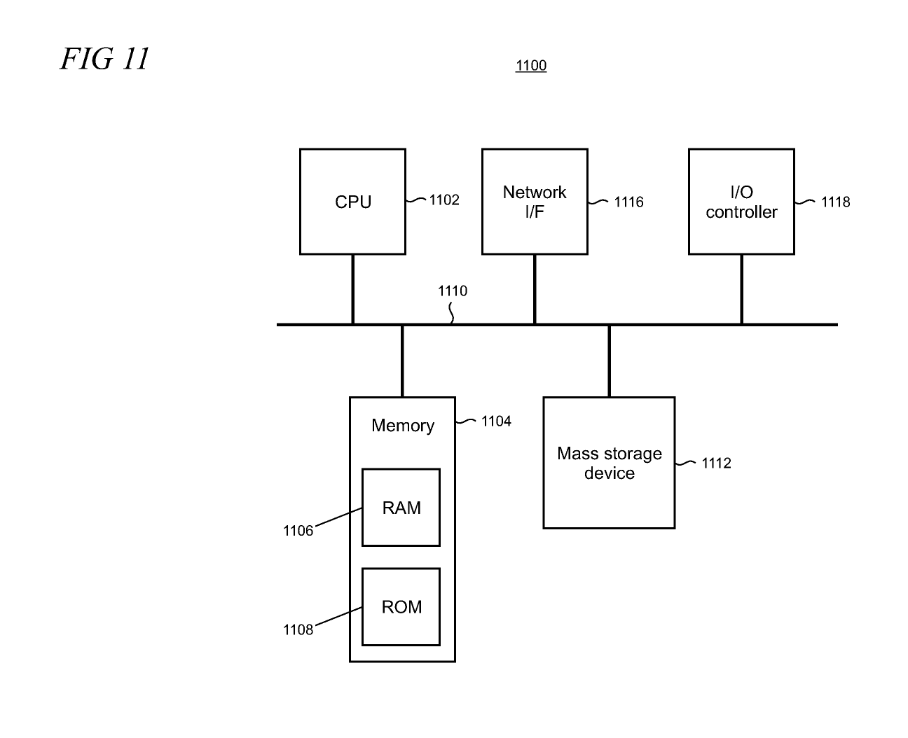

It may be desirable and/or advantageous to enable other types of computing platforms other than the multimedia console 410 to implement the present incentives for acknowledging product advertising within media content in some applications. For example, a game and signal capture client may be readily adapted to run on various fixed computing platforms and mobile computing platforms. FIG. 11 shows an illustrative architecture 1100 for a computing platform or device capable of executing the various components described herein for providing incentives for acknowledging product advertising within media content. Thus, the architecture 1100 illustrated in FIG. 11 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 1100 may be utilized to execute any aspect of the components presented herein.

The architecture 1100 illustrated in FIG. 11 includes a CPU 1102, a system memory 1104, including a RAM 1106 and a ROM 1108, and a system bus 1110 that couples the memory 1104 to the CPU 1102. A basic input/output system containing the basic routines that help to transfer information between elements within the architecture 1100, such as during startup, is stored in the ROM 1108. The architecture 1100 further includes a mass storage device 1112 for storing software code or other computer-executed code that is utilized to implement applications, the file system, and the operating system.

The mass storage device 1112 is connected to the CPU 1102 through a mass storage controller (not shown) connected to the bus 1110. The mass storage device 1112 and its associated computer-readable storage media provide non-volatile storage for the architecture 1100. Although the description of computer-readable storage media contained herein refers to a mass storage device, such as a hard disk or CD-ROM drive, it should be appreciated by those skilled in the art that computer-readable media can be any available computer storage media that can be accessed by the architecture 1100.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 1100.

According to various embodiments, the architecture 1100 may operate in a networked environment using logical connections to remote computers through a network. The architecture 1100 may connect to the network through a network interface unit 1116 connected to the bus 1110. It should be appreciated that the network interface unit 1116 also may be utilized to connect to other types of networks and remote computer systems. The architecture 1100 also may include an input/output controller 1118 for receiving and processing input from a number of other devices, including a keyboard, mouse, or electronic stylus (not shown in FIG. 11). Similarly, the input/output controller 1118 may provide output to a display screen, a printer, or other type of output device (also not shown in FIG. 11).

It should be appreciated that the software components described herein may, when loaded into the CPU 1102 and executed, transform the CPU 1102 and the overall architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 1100 in order to store and execute the software components presented herein. It also should be appreciated that the architecture 1100 may include other types of computing devices, including hand-held computers, embedded computer systems, smartphones, PDAs, and other types of computing devices known to those skilled in the art. It is also contemplated that the architecture 1100 may not include all of the components shown in FIG. 11, may include other components that are not explicitly shown in FIG. 11, or may utilize an architecture completely different from that shown in FIG. 11.

Based on the foregoing, it should be appreciated that technologies for incentives for acknowledging product advertising within media content have been disclosed herein. Although the subject matter presented herein has been described in language specific to computer structural features, methodological and transformative acts, specific computing machinery, and computer readable storage media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A method for providing a reward to a user of a device on which media content is consumable, the method comprising the steps of:
receiving signals representative of user actions, the user actions being performed in response to a reward offer, the received signals being captured at the device as the media content is consumed and providing a user acknowledgement of an instance of an observed product placement within the media content;
comparing the captured signals against one or more rules, the rules expressing reward criteria by which a reward is achievable by the user; and
providing the reward to the user when results from the comparing indicate that the reward criteria are satisfied.

2. The method of claim 1 further comprising a step of archiving the captured signals in a store.

3. The method of claim 1 further comprising a step of providing one of a digital reward or a physical reward to the user.

4. The method of claim 1 further comprising a step of providing reward fulfillment instructions to the user.

5. The method of claim 1 in which the rules are set by a brand owner.

6. The method of claim 1 in which the rules are set on a media content title-by-title basis.

7. The method of claim 1 further comprising a step of generating a report that includes statistical data that identifies instances in which users explicitly acknowledged a product placement within media content over a time interval.

8. The method of claim 1 in which the reward criteria specify at least one of user actions, media timecodes, time limits, or reward information, the media timecodes specifying a time during which a product placement is viewable or audible in the media content, the time limits expressing a time period in which a user is eligible to achieve the reward.

9. The method of claim 1 further comprising implementing the steps of receiving, comparing, and providing using an achievement system.

10. The method of claim 9 in which the achievement system is implemented as a portion of an entertainment service.

11. A system for receiving rewards, comprising:
at least one processor; and
memory operatively coupled to the processor and storing computer-readable instructions that, when executed by the at least one processor, implement a client that performs a method comprising the steps of:
receiving media content,
rendering the media content,
capturing signals representative of user actions, the user actions being performed in response to a reward offer, the signals being captured at the system as the media content is rendered and providing a user acknowledgement of an instance of an observed product placement within the media content,
transmitting the captured signals to a remote service, the remote service being configured for comparing the captured signals against one or more rules, the rules expressing reward criteria by which a reward is achievable by a user, the remote service being further configured for providing the reward to the user when reward criteria are satisfied,
receiving metadata associated with the media content, the metadata including the reward offer, and
populating a user interface with the reward offer, the reward offer identifying the reward and further identifying user actions that, when performed by the user to acknowledge one or more product placements in the media content, satisfy the reward criteria.

12. The system of claim 11 in which the processor and memory are incorporated into a device being one of multimedia console, mobile phone, smartphone, tablet, personal computer (“PC”), personal digital assistant (“PDA”), handheld gaming platform, personal media player, wearable computer, or navigation device.

13. The system of claim 11 in which the client is instantiated in a media content application that is executable on the system.

14. The system of claim 11 in which the client is instantiated in either an operating system executing on the system or in an application layer executing on the system.

15. One or more computer-readable storage media containing instructions which, when executed by one or more processors disposed in an electronic device, perform a method for providing incentives to consumers of media content to acknowledge a product placement in the media content, the method comprising the steps of:
receiving rules that express reward criteria for achieving an award;
using the received rules to generate metadata that includes a reward offer; and
sending the media content and the metadata to a remote client device, the metadata being usable at the remote client device to populate a user interface with the reward offer and to show on the user interface user actions that, when performed by a user of the device to acknowledge one or more product placements in the media content, satisfy the reward criteria.

16. The one or more computer-readable storage media of claim 15 in which the method further includes a step of sending the media content and metadata in one of download or stream.

17. The one or more computer-readable storage media of claim 15 in which the user actions comprise an input to the user interface, the input being one of gesture, body motion, voice-command, physical control interaction, or control object interaction.

18. The one or more computer-readable storage media of claim 15 in which the user interface is configured to show progress towards a reward or achievement of a reward.

19. The one or more computer-readable storage media of claim 15 in which the metadata includes code for generating one of text, graphics, or animations to be rendered on the user interface.

20. The one or more computer-readable storage media of claim 15 in which the media content is one of television show or movie.
